(19) United States
(12) Patent Application Publication
(10) Pub. No.: US 2013/0037657 A1
(43) Pub. Date: Feb. 14, 2013

(54) VORTEX GENERATORS

(71) Applicant: ROBERT E. BREIDENTHAL, SEATTLE, WA (US)

(72) Inventor: ROBERT E. BREIDENTHAL, SEATTLE, WA (US)

(73) Assignee: RAMGEN POWER SYSTEMS, LLC, BELLEVUE, WA (US)

(21) Appl. No.: 13/542,673

(22) Filed: Jul. 6, 2012

Related U.S. Application Data
(60) Provisional application No. 61/506,055, filed on Jul. 9, 2011.

(51) Int. Cl. F15D 1/12; B64C 5/06; F03D 11/00; B64C 3/00; B62D 35/00; B64C 21/00; B64C 9/00

(52) U.S. Cl. 244/204.1; 244/91; 244/87; 137/561 A; 296/180.1; 416/223 R

(57) ABSTRACT

A vortex generator, or an array of vortex generators, for attenuating flow separation during flow of fluid over a surface. Vortex generators include a base with a forward end and a leading edge extending outward and rearward from the forward end to an outward end. The leading edge includes a first angular discontinuity at a height H₁ above the base, and a second angular discontinuity at a height H₂ above the base. The vortex generator(s) are configured for generating, adjacent a surface, at least two (2) vortices V₁ and V₂ in a fluid, and turning the outermost generated vortice toward the surface over which the fluid is passing.

CROSS-REFERENCE TO RELATED APPLICATIONS

This application claims priority from prior pending U.S. Provisional Patent Application Ser. No. 61/506,055, for a SUPERSONIC COMPRESSOR, filed Jul. 9, 2011, the contents of which are incorporated herein by this reference.

### STATEMENT OF GOVERNMENT INTEREST

This invention was made with United States Government support under Contract No. DE-FE0000493 awarded by the United States Department of Energy. The United States Government has certain rights in the invention.

### COPYRIGHT RIGHTS IN THE DRAWING

A portion of the disclosure of this patent document contains material that is subject to copyright protection. The applicant has no objection to the facsimile reproduction by anyone of the patent document or the patent disclosure, as it appears in the Patent and Trademark Office patent file or records, but otherwise reserves all copyright rights whatsoever.

### TECHNICAL FIELD

This description relates to vortex generators for mixing of fluids during fluid flow.

### BACKGROUND

A continuing interest exists in industry for improved vortex generators for simply, reliably, and efficiently mixing fluids. Such devices may be useful in a variety of applications. Further, from the point of view of efficiency, it would be desirable to enhance efficiency of various components, for example, aircraft wings, or wind turbine blades, by reducing parasitic losses due to boundary layer phenomenon. Thus, it can be appreciated that it would be advantageous to provide novel, highly efficient vortex generator designs that enhance the mixing of fluids adjacent surfaces along which fluids flow.

Although a variety vortex generator designs are known for energizing and minimizing perturbations caused by boundary layer interaction with passing bulk fluid flow, there remains ti need for further improvement, especially as related to high speed air flow, or trans-sonic air flow, as might be encountered on wings and tail surfaces of high speed aircraft. Improvements in performance over existing devices would allow incremental reductions in drag, and thus, improve efficiency, and provide significant fuel savings, over time.

### SUMMARY

A novel vortex generator design has been developed that, in an embodiment, enhances vortex development by utilizing one or more additional vortices to further energize an initially formed vortex. In an embodiment, two or more vortices may be generated by each vortex generator. In an embodiment, three or more vortices may be generated by each vortex generator. In an embodiment, an array of vortex generators of selected size and shape may be deployed to collectively provide cooperating vortices. In either manner, increasingly smaller vortices that are developed outwardly from a surface may be utilized to energize larger vortices that are initially developed in position closer to a surface over which fluid flows. In one aspect, a first vortice may be used to turn a second vortice from an outward position toward an inward position adjacent a surface, to thus mix and energize the boundary layer.

Without limitation, various examples are provided herein. For example, in an embodiment, vortex generators may be provided to generate two vortices. In an embodiment, vortex generators may be provided to generate three vortices. In various applications, such vortex generators may be applied in a variety of fluids, whether air, water, or in a variety of fluids being processed, whether gaseous or liquid in nature.

Generally, for minimization of adverse aerodynamic or hydrodynamic effects, and for improving efficiency of fluid flow past a surface, one or more vortex generators may be utilized as boundary layer control structures. Generally, a plurality of vortex generators may be utilized on a selected apparatus in any given application. Such vortex generators may be selected from one or more types of vortex generators, whether utilizing the generation of two vortices by a single vortex generator, or the generation of three or more vortices by a single vortex generator. Generally, such vortex generators energize a boundary layer by mixing the boundary layer with the bulk fluid flow stream, into which the vortex generator extends. More generally, in various embodiments, the vortex generators may generate multiple vortices, wherein a larger vortex rotates a simultaneously generated, adjacent, and smaller vortex toward and thence into a boundary layer, and thus controls such boundary layer as the smaller vortex mixes with the boundary layer.

Finally, for different fluid flow applications, a variety of configurations, particularly in detailed vortex generator geometry and in numbers and location for their placement, may be made by those skilled in the art and to whom this specification is directed, without departing from the teachings hereof.

### BRIEF DESCRIPTION OF THE DRAWINGS

Configurations for vortex generators will be described by way of exemplary embodiments, using for illustration the accompanying drawing figures in which like reference numerals denote like elements, and in which:

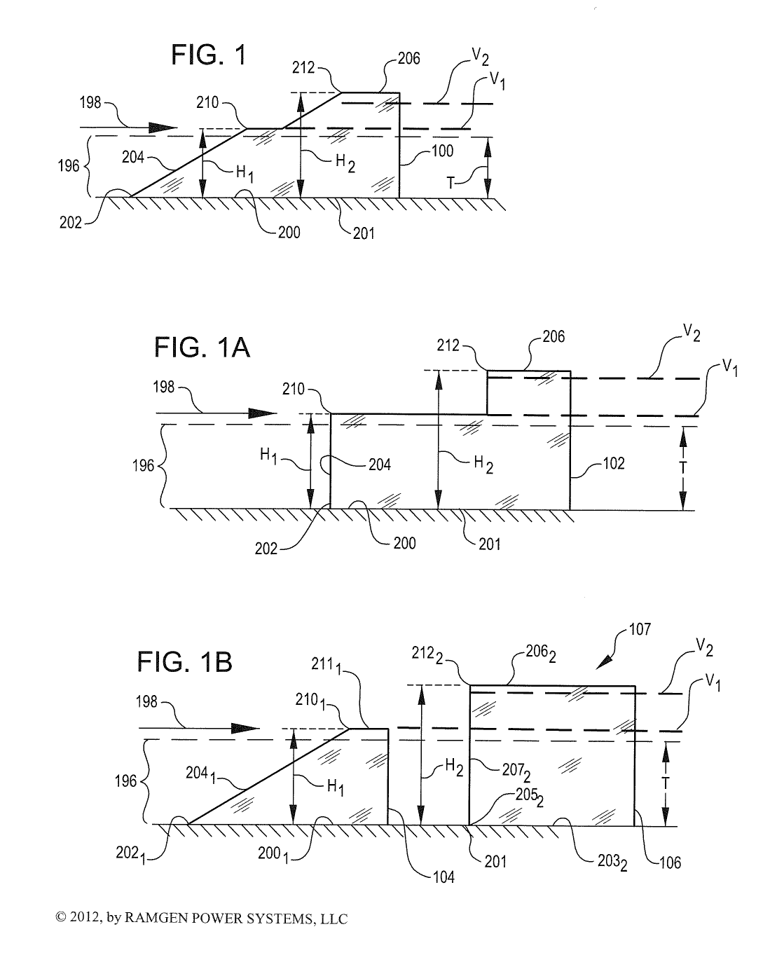

FIG. 1 is a diagrammatic side view for an embodiment for a vortex generator affixed to a selected surface over which fluid flows, wherein the vortex is designed to generate at least one (1) vortex, and here showing the generation of two (2) cooperating vortices from an incoming gas flow as indicated by heavy broken lines.

FIG. 1A is a diagrammatic side view for an embodiment for a vortex generator affixed to a selected surface over which fluid flows, wherein the vortex is designed to generate at least one (1) vortex, and here showing the generation of two (2) cooperating vortices from an incoming gas flow as indicated by heavy broken lines, and which is provided in a staircase planform, rather than the swept delta planform as shown in FIG. 1.

FIG. 1B is a diagrammatic side view for an embodiment for a configuration of a vortex generator array, where two separate vortex generators of different height are affixed to a selected surface over which fluid flows, wherein the configuration of the two (2) vortex generators is designed to generate at least two (2) cooperating vortices from an incoming gas flow as indicated by heavy broken lines, and in which one (1) vortex generator is provided in a staircase planform, and one vortex generator is provided in a swept delta planform.

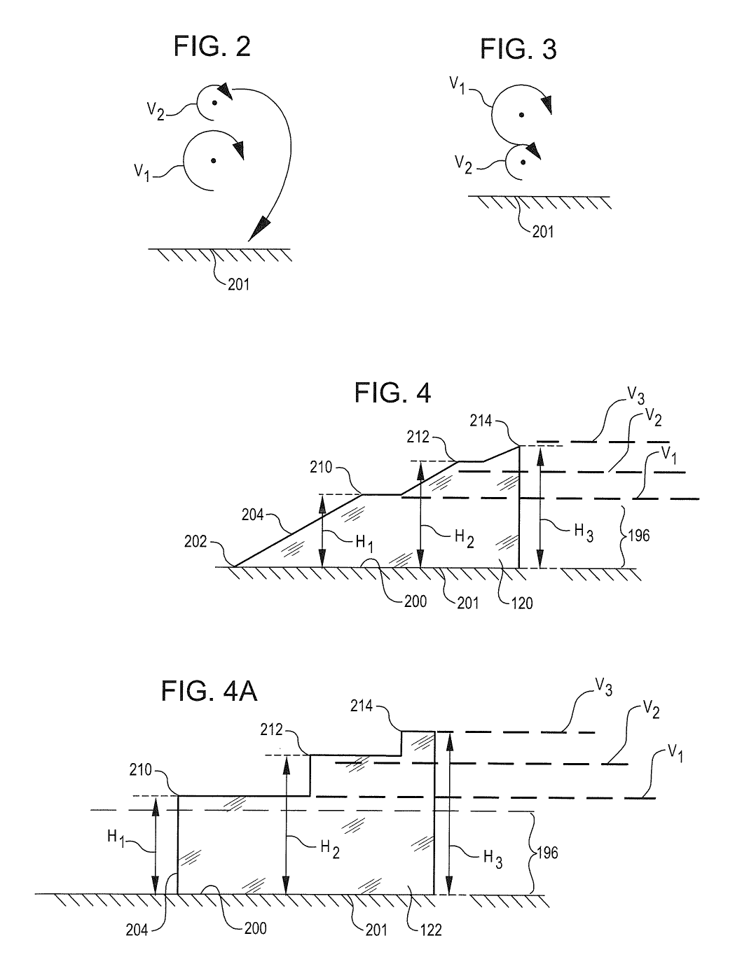

FIG. 2 is a diagrammatic end view for the operation of an embodiment of a vortex generator as just illustrated in FIG. 1 above, or in FIG. 1A above, showing two (2) vortices, a larger one and a smaller one, as first generated above a selected surface over which a fluid is flowing.

FIG. 3 is a diagrammatic end view for the operation of an embodiment of a vortex generator as just illustrated in FIGS. 1, 1A, and 2 above, showing two (2) vortices, a larger one and a smaller one, as the two vortices turn and flip the smaller vortex downward against the selected surface over which fluid is flowing, so as to become located in a position for effecting work on a boundary layer adjacent the selected surface.

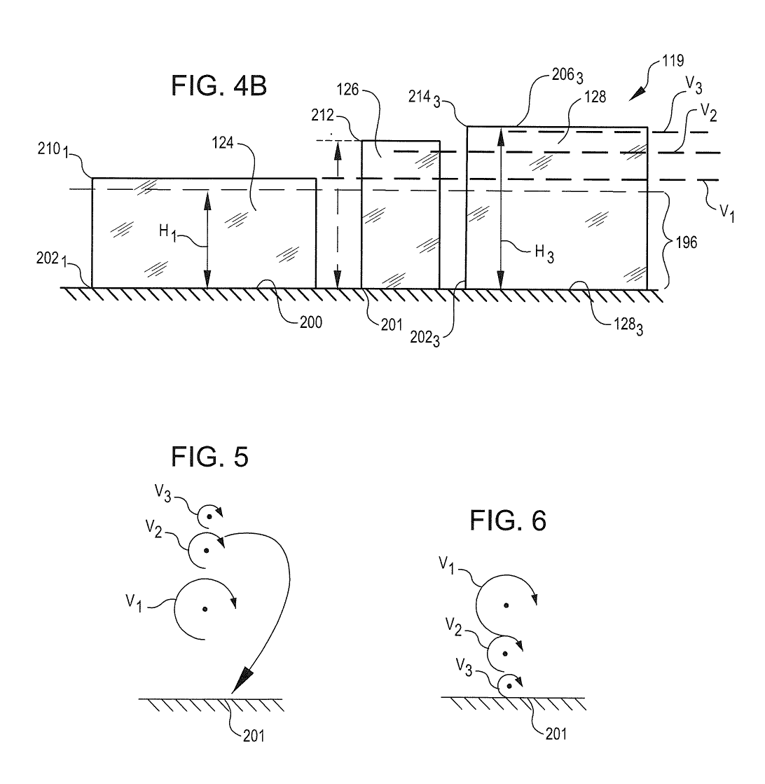

FIG. 4 is a diagrammatic side view for an embodiment for a vortex generator affixed to a selected surface over which fluid is flowing, wherein the vortex is designed to generate at least one (1) vortex, and here showing the generation of three (3) vortices from an incoming gas flow as indicated by heavy broken lines.

FIG. 4A is a diagrammatic side view for an embodiment for a vortex generator affixed to a selected surface over which fluid is flowing, wherein the vortex is designed to generate at least one (1) vortex, and here showing the generation of three (3) cooperating vortices from an incoming gas flow as indicated by heavy broken lines, and in which the vortex generator is provided in a staircase planform, rather than the swept delta planform as shown in FIG. 4.

FIG. 4B is a diagrammatic side view for an embodiment for a configuration for a vortex generator array, where three (3) separate vortex generators of different height are affixed to a selected surface over which fluid flows, wherein the configuration of the three (3) vortex generators is designed to generate at least three (3) cooperating vortices from an incoming gas flow as indicated by heavy broken lines, and in which the vortex generators are each provided in a staircase planform.

FIG. 5 is a diagrammatic end view for the operation of an embodiment of a vortex generator as just illustrated in FIG. 4, or in FIG. 4A above, showing three (3) vortices, a large one, an intermediate sized one, and a small one, as first generated above a selected surface of over which fluid is flowing.

FIG. 6 is a diagrammatic end view for the embodiment of a vortex generator as just illustrated in FIGS. 4, 4A, and 5 above, showing three (3) vortices, a large one, an intermediate sized one, and a small one, as they turn and flip the smaller vortices downward against the selected surface over which fluid is flowing, so as to become located in a position for effecting work on a boundary layer adjacent the selected surface.

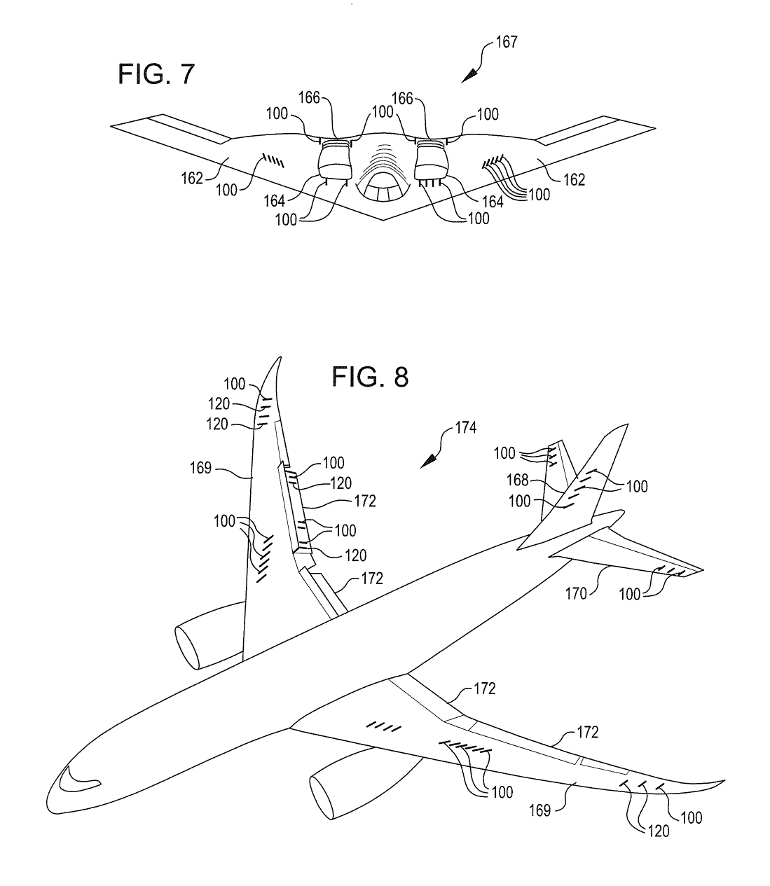

FIG. 7 provides a perspective view of a low observability profile aircraft that utilizes S-ducts with respect to engine inlets and outlets, which S-duct, and inlets and outlets thereof, may benefit from use of the vortex generator designs depicted herein.

FIG. 8 illustrates a commercial aircraft having wings, control surfaces, and vertical and horizontal stabilizers which may benefit from use of the vortex generator designs described herein for attenuating boundary layer growth along surfaces exposed to airflow.

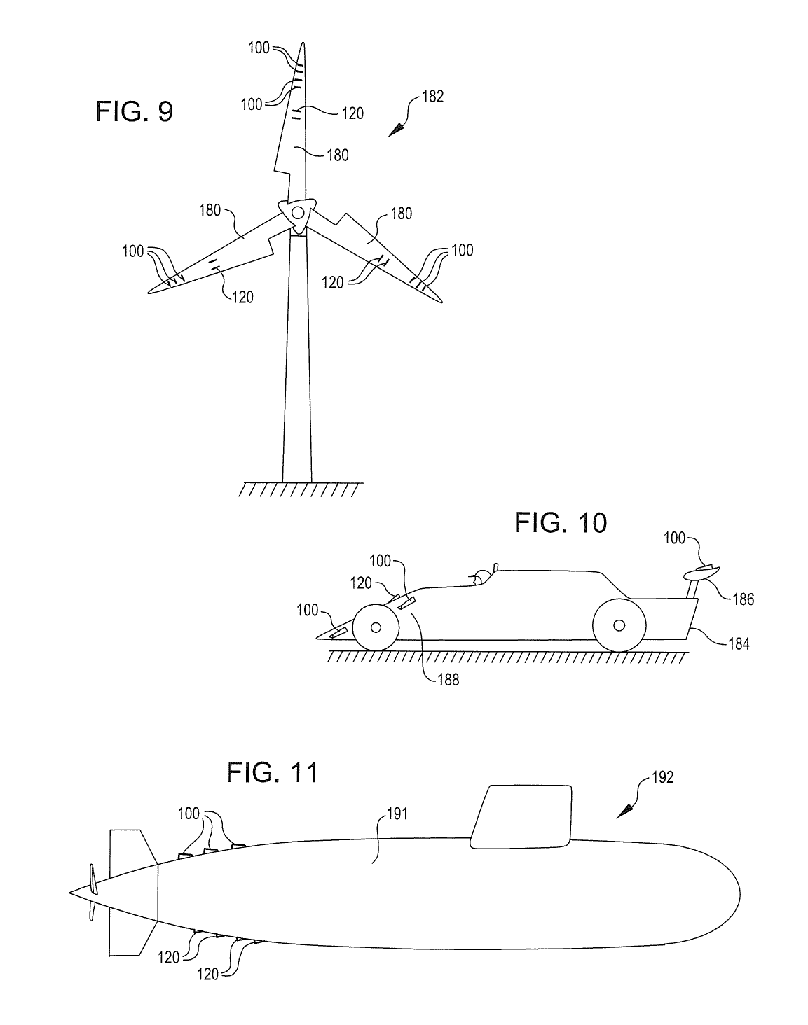

FIG. 9 illustrates a wind turbine, having blades where efficiency may be enhanced by use of the vortex generator designs described herein for attenuating boundary layer growth along surfaces exposed to airflow.

FIG. 10 illustrates the use of vortex generators as described herein on land vehicles, here providing a racing car, where a cab portion initially exposed to air flow, and a down force fin that it exposed to air flow, are utilizing the vortex generators as described herein.

FIG. 11 illustrates use of a vortex generator generally of the type described herein in hydrodynamic applications, such as on surfaces of a submarine, where maintaining smooth fluid flow may be important with respect to noise attenuation, as well as operating efficiency.

The foregoing figures, being merely exemplary, contain various elements that may be present or omitted from actual vortex generator designs utilizing the principles taught herein, or that may be implemented in various applications for such vortex generators. Variant vortex generator designs may use slightly different aerodynamic or hydrodynamic structures, mechanical attachment arrangements, or process flow configurations, and yet employ the principles described herein or depicted in the drawing figures provided. An attempt has been made to draw the figures in a way that illustrates at least those elements that are significant for an understanding of an exemplary vortex generator design. Such details should be useful for providing a useful vortex generator design for various applications. In particular, such vortex generators should be useful for controlling boundary layer separation phenomenon that may be associated with high velocity gas adjacent aircraft surfaces, such as S-ducts associated with low heat signature engine inlets and outlets, or with wing surfaces, or with vertical stabilizer surfaces, or with related control surfaces.

It should be understood that various features may be utilized in accord with the teachings hereof, as may be useful in different embodiments as necessary or useful for vortex generator applications in the flow of various fluids, whether gases or liquids, and depending upon the conditions of service, such as temperatures and pressures of a gas being processed, or merely passing the vortex generator, within the scope and coverage of the teaching herein as defined by the claims.

### DETAILED DESCRIPTION

The following detailed description, and the accompanying figures of the drawing to which it refers, are provided describing and illustrating some examples and specific embodiments of various aspects of the invention(s) set forth herein, and are not for the purpose of exhaustively describing all possible embodiments and examples of various aspects of the invention(s) described and claimed below. Thus, this detailed description does not and should not be construed in any way to limit the scope of the invention(s) claimed in this or in any related application or resultant patent.

To facilitate the understanding of the subject matter disclosed herein, a number of terms, abbreviations or other shorthand nomenclature are used as set forth herein below. Such definitions are intended only to complement the usage common to those of skill in the art. Any term, abbreviation, or shorthand nomenclature not otherwise defined shall be understood to have the ordinary meaning as used by those skilled artisans contemporaneous with the first filing of this document.

In this disclosure, the term “aerodynamic” should be understood to include not only the handling of air, but also the handling of other gases within the compression and related equipment otherwise described. Thus, more broadly, the term “aerodynamic” should be considered herein to include gas dynamic principles for gases other than air. For example, various relatively pure gases, or a variety of mixtures of gaseous elements and/or compounds, may be encountered in various industrial processes, and thus as applicable the term “aerodynamic” shall also include the use of gases or gas mixtures other than air.

In this disclosure, the term “hydrodynamic” should be understood to include not only the flow of water, including seawater, but also the handling of other liquids within process equipment, unless otherwise noted. Thus, more broadly, the term “hydrodynamic” should be considered herein to include fluid flow principles for liquids other than water. For example, various relatively pure liquids, or a variety of mixtures of liquid compounds, may be processed through equipment where drag reduction due to boundary payer phenomenon may be useful, and thus as applicable the term “hydrodynamic” shall include the processing of various liquids through liquids other than water in what may be considered a hydrodynamic flow.

The term “inlet” may be used herein to define an opening designed for receiving fluid flow. For example, in an aerodynamic S-duct for an aircraft engine, the aerodynamic S-duct has an inlet having an inlet cross-sectional area that is shaped to capture and ingest gas to be processed through the aircraft engine. Inlets may have a large variety of shapes, and when turns are made at or within such inlets, for example for use in low profile observability applications, control of boundary layer phenomenon within such inlets is often of concern.

The term “outlet” may be used herein to define a discharge opening designed for discharging fluid flow. For example, in an aerodynamic S-duct for an aircraft engine, the aerodynamic duct has an outlet of selected cross-sectional area that is shaped to route and discharge hot exhaust gases as they are emitted from an aircraft engine. Outlets may have a large variety of shapes, and when turns are made in such outlets, or within ducts leading to such outlets, for example for low profile observability applications in aircraft, then boundary layer control within the outlet is often of concern.

As generally seen in FIG. 1, in an embodiment, vortex generators 100 and/or 120 may be sized and shaped in a manner so as to mix high momentum bulk fluid flow indicated by arrow 198 into a boundary layer 196 and along a surface 201, to scrub the boundary layer 196, so that the boundary layer thickness T is minimized, after such mixing.

Turning now to FIGS. 1 through 6, in an embodiment, boundary layer control structures may be provided as vortex generators, such as vortex generators 100 or 120. Further, as shown in FIGS. 7, a vortex generator 100 may be located on a aerodynamic surface such as the wing 162 or other surfaces such as S-duct engine inlet 164 or outlet 166 components of an aircraft 167. Likewise, as indicated in FIG. 8, vortex generators 100 or 120 may be located on wings 169, or vertical stabilizer 168, horizontal stabilizer 170, or control surfaces such as flaps 172 of an aircraft 174. Further, as indicated in FIG. 9, vortex generators 100 and/or 120 may be located on the blades 180 of a wind turbine 182. Land vehicles, such as over the road trucks, or a race car 184 as shown in FIG. 10, may utilize vortex generators 100 and/or 120 on appropriate surfaces, such as down force fin 186, or on cab surface 188. Similarly, as depicted in FIG. 11, a vortex generators 100 and or 120 may be located on hydrodynamic surfaces 190, such as the hull 191 of a submarine 192. Generally, wherever a low momentum boundary layer forms during fluid flow, mixing with higher energy bulk fluid flow using the novel vortex generator design(s) disclosed herein may tend to attenuate flow separation, reduce drag, and improve overall performance.

As shown in FIG. 1, a boundary layer 196 of thickness T may occur in the flow of a bulk fluid as indicated by reference arrow 198. Located adjacent surface 201, vortex generator 100 is able to bring energy from the higher energy bulk fluid indicated by arrow 198 to the boundary layer 196. The vortex generator 100 may include a base 200 attached to a suitable surface 201 with a forward end 202 and a leading edge 204 extending outward and rearward. i.e., in a downstream direction from the forward end 202 of the base to an outward end 206. In an embodiment, the leading edge 204 includes at least one angular discontinuity 210 along a first leading edge 204, for generating at least one vortex. In an embodiment, the leading edge 204 includes a first angular discontinuity 210 at a height H₁ above the base 200, and a second angular discontinuity 212 at a height H₂ above the base 200, for generating two vortices. As shown for vortex generator 120 in FIG. 4, in an embodiment, the leading edge 204 includes a first angular discontinuity 210 at a height H₁ above the base 200, a second angular discontinuity 212 at a height H₂ above the base 200, and a third angular discontinuity 214 at a height H₃ above the base 200, for generating three vortices. In various embodiments, a plurality of vortex generators 100 and/or 120 may be provided on a fluid dynamic surface, as illustrated in any one of the FIG. 7, 8, 9, 10, or 11. Vortex generators may be provided in the just described novel configurations, or variations thereof.

In an embodiment, vortex generators may be provided having height H₁ that is about 1.6 times the result of height H₂ minus height H₁. In an embodiment, height H₂ may be about 1.6 times the result of height H₃ minus height H₂. Thus, in an embodiment, the height ratios of discontinuities in vortex generators for generating vortices in the respective multi-vortex embodiments may be about 1.6, roughly the so called “golden ratio”. Generally, the golden ratio (more precisely 1.618) is denoted by the Greek lowercase letter phi (φ). With respect to vortex strength, if the height ratios are equal to phi (φ), then the strength ratios, that is the comparative strength between the first and second vortices, may be equal to (φ)⁻². Generally, as depicted between FIGS. 2 and 3, and likewise in FIGS. 5 and 6, in a vortex generator design, a useful technique may be to use the larger, and stronger vortex, say V₁, to turn a smaller vortex, say, V₂, toward the surface 201. Likewise, with three vortices, such technique involves turning the larger and stronger vortices, say V₁ and V₂, to drive the smaller vortex V₃ toward the surface 201. In such manner, a larger vortex V₁, which might not otherwise be able to mix with a boundary layer 196 of thickness T adjacent surface 201, is able to bring energy to mix higher energy bulk fluid indicated by arrow 198 with the boundary layer 196 by virtue of carriage of the smaller vortex V₃ toward surface 201.

Turning now to the embodiment illustrated in FIG. 1A, a diagrammatic side view is shown for a vortex generator 102 affixed to a selected surface 201 over which fluid flows, showing incoming gas flow 198. The vortex generator 102 is designed to generate of two (2) cooperating vortices V₁ and V₂ as indicated by heavy broken lines. The vortex generator 102 is provided in a staircase planform, rather than the swept delta planform of vortex generator 100 as shown in FIG. 1.

Similar cooperating vortices are produced by the configuration of single vortex generators as depicted in FIG. 1B. That drawing figure provides a diagrammatic side view for an embodiment for a configuration of vortex generators, wherein two separate vortex generators 104 and 106, of different height are affixed to a selected surface 201 over which fluid flows. The configuration of the two vortex generators 104 and 106 is designed to generate at least two (2) cooperating vortices V₁ and V₂ as indicated by heavy broken lines, and as further depicted in FIG. 2, from an incoming gas flow 198. Vortex generator 104 is provided in a swept delta planform, and vortex generator 106 is provided in a staircase planform. Vortex generator array 107 includes the first 104 and second 106 vortex generators. The first vortex generator 104 has a first base 200₁ with a forward end 202₁ and a leading edge 204₁ extending outward from said forward end 202₁ to an outward end 211₁. The leading edge 204₁ has a first angular discontinuity 210₁ at a height H₁ above the base 200₁. As noted, the first vortex generator 104 is sized and shaped to generate a first vortice V₁ in the flowing fluid 198. A second vortex generator 106 is provided. The second vortex generator 106 has a second base 203₂ with a second forward end 205₂ and a second leading edge 207₂ extending outward from the second forward end 205₂ to a second outward end 206₂. The second outward end 206₂ has a second angular discontinuity 212₂ at a height H₂ above the second base 203₂. The second vortex generator 106 sized and shaped to generate a second vortice V₂ in the flowing fluid 198. The first vortex generator 104 and the second vortex generator 106 are sized, shaped, and spaced in vortex generator array 107 so that vortice V₁ is first generated adjacent surface 201, and wherein the second vortice V₂ is first generated outward from vortice V₁, and wherein momentum imparted to the fluid 198 by the first vortex generator 104 and by the second vortex generator 106 rotates vortice V₂ toward the surface 201.

FIG. 4A is a diagrammatic side view for an embodiment for a vortex generator 122 affixed to a selected surface 201 over which fluid is flowing. The vortex generator 122 is designed to generate at least three (3) cooperating vortices V₁, V₂, and V₃ as indicated by heavy broken lines and as further depicted in FIG. 5. The vortex generator 122 is provided in a staircase planform, rather than the swept delta planform as shown in FIG. 4.

Cooperating vortices similar to those provided by vortex generator 122 are produced by the array 119 of vortex generators 124, 126, and 128 as depicted in FIG. 4B. In that figure, a diagrammatic side view for an embodiment for a configuration of vortex generators 124, 126, and 128 is provided, and wherein those three separate vortex generators are of different height and are affixed to a selected surface 201 over which fluid flows. The configuration of the three vortex generators 124, 126, and 128 is designed to generate at least three (3) cooperating vortices V₁, V₂, and V₃ from an incoming gas flow 198 as indicated by heavy broken lines. Although each of such vortex generators are shown in staircase planform, they might alternately be provided in a swept delta planform.

As shown in FIG. 4B, a third vortex generator 128 may have a third base 128₃, with a third forward end 202₃ and a third leading edge 207₃ extending outward from the third base 128₃ to a third outward end 206₃. The third outward end 206₃ has a third angular discontinuity 214₃ at a height H₃ above the third base 128₃. The third vortex generator 128 may be sized and shaped to generate a third vortice V₃ in the flowing fluid 198. The vortice V₃ is first generated adjacent the vortice V₂. and momentum imparted to the flowing fluid by the vortex generator array 119 rotates the vortice V₃ toward the surface 201 on which third vortex generator 128 is mounted.

The vortex generators 100 and/or 120 may be designed, i.e., sized and shaped, for an inlet relative Mach number for operation associated with a design operating point selected within a design operating envelope for a bulk flow gas 198 composition, density, temperature, and velocity. A design may be configured for a selected mass flow, that is for a particular quantity of gas that is to be mixed, and that gas may have certain inlet conditions with respect to temperature and pressure (or an anticipated range of such conditions), that should be considered in the design. The incoming gas may be relatively pure, of single or multiple components, or may be expected to be variable in composition. And, it may be desired to achieve a particular final amount of mixing, when starting at a given inlet condition, thus size and shape must be selected in particular designs. The designs described herein allow use in high speed airflow conditions, including transonic or supersonic conditions, and thus are believed superior to prior art designs, especially those primarily directed to subsonic conditions.

Means for attenuating boundary layer growth during fluid flow are described herein. The means for controlling boundary layers may include the use of one or more vortex generators to energize a boundary layer by moving gas via a vortex from a higher velocity bulk flow portion into a slower boundary layer flow, to thereby energize the boundary layer flow.

In addition to air, various gases or gas mixtures thereof may be engaged by vortex generators of the type described herein. Such devices may be useful during compression or processing of various hydrocarbon gases, such as ethane, propane, butane, pentane, or hexane. Further, gases or gas mixtures having a molecular weight of at least that of gaseous nitrogen (MW=28.02) may be particularly well suited, but of course, benefits of use in various gases may vary widely, depending upon the temperature, pressure, and bulk gas velocity for the anticipated use. More generally, use associated with compression of those gases wherein Mach 1 occurs at relatively low velocity, such as that of methane (1440 feet/sec), and lower (such as ammonia, water vapor, air, carbon dioxide, propane, R410a, R22, R134a, R12, R245fa, and R123), may benefit from efficient boundary layer mixing as taught herein.

In summary, the various embodiments using vortex generators as taught herein are expected to provide significantly improved performance over prior vortex generator designs, particularly when operating at transonic or supersonic inlet conditions in air.

In the foregoing description, for purposes of explanation, numerous details have been set forth in order to provide a thorough understanding of the disclosed exemplary embodiments for the design(s) of and applications for novel vortex generators. However, certain of the described details may not be required in order to provide useful embodiments, or to practice a selected or other disclosed embodiments. Further, for descriptive purposes, various relative terms may be used. Terms that are relative only to a point of reference are not meant to be interpreted as absolute limitations, but are instead included in the foregoing description to facilitate understanding of the various aspects of the disclosed embodiments. And, various actions or activities in a method described herein may have been described as multiple discrete activities, in turn, in a manner that is most helpful in understanding the present invention. However, the order of description should not be construed as to imply that such activities are necessarily order dependent. In particular, certain operations may not necessarily need to be performed precisely in the order of presentation. And, in different embodiments of the invention, one or more activities may be performed simultaneously, or eliminated in part or in whole while other activities may be added. Also, the reader will note that the phrase “in an embodiment” or “in one embodiment” has been used repeatedly. This phrase generally does not refer to the same embodiment; however, it may. Finally, the terms “comprising”, “having” and “including” should be considered synonymous, unless the context dictates otherwise.

From the foregoing, it can be understood by persons skilled in the art that novel vortex generators have been provided for the efficient mixing of boundary layers with bulk fluid flows. Although certain specific embodiments of the novel vortex generators have been shown and described, there is no intent to limit the vortex generators by these embodiments, or to the described applications for such vortex generators. Rather, the novel vortex generators described herein are to be defined by the appended claims and their equivalents when taken in combination with the description.

Importantly, the aspects and embodiments described and claimed herein may be modified from those shown without materially departing from the novel teachings and advantages provided, and may be embodied in other specific forms without departing from the spirit or characteristics thereof. Therefore, the embodiments presented herein are to be considered in all respects as illustrative and not restrictive or limiting. As such, this disclosure is intended to cover the structures described herein and not only structural equivalents thereof, but also equivalent structures. Numerous modifications and variations are possible in light of the above teachings. Therefore, the protection afforded should be limited only by the claims set forth herein, and the legal equivalents thereof.

1. A vortex generator for attenuating flow separation during flow of a fluid over a surface, comprising:
a base with a forward end and a leading edge extending outward and rearward from said forward end to an outward end, said leading edge comprising
(a) a first angular discontinuity at a height H₁ above said base, and
(b) a second angular discontinuity at a height H₂ above said base, said vortex generator configured for generating, adjacent said surface, at least two vortices V₁ and V₂ in said fluid.

2. A vortex generator as set forth in claim 1, wherein height H₁ is about 1.6 times the result of height H₂ minus height H₁.

3. A vortex generator as set forth in claim 1, wherein vortice V₁ is first generated adjacent said base, and wherein said vortice V₂ is first generated outward from vortice V₁, and wherein momentum imparted to said fluid by said vortex generator rotates said vortice V₂ toward said base.

4. A vortex generator as set forth in claim 1, wherein said leading edge further comprises a third angular discontinuity at a height H₃ above said base, said vortex generator configured for generating a third vortice V₃.

5. A vortex generator as set forth in claim 4, wherein height H₂ is about 1.6 times the result of height H₃ minus height H₂.

6. A vortex generator as set forth in claim 4, wherein vortice V₃ is first generated adjacent said vortice V₂, and wherein momentum imparted to said fluid by said vortex generator rotates said vortice V₃ toward said base.

7. An aircraft, said aircraft comprising:
a plurality of vortex generators for attenuating flow separation during flow of a fluid over a surface, said vortex generators comprising a base with a forward end and a leading edge extending outward and rearward from said forward end to an outward end, said leading edge comprising
(a) a first angular discontinuity at a height H₁ above said base, and
(b) a second angular discontinuity at a height H₂ above said base, said vortex generator configured for generating, adjacent said surface, at least two vortices V₁ and V₂ in said fluid.

8. An aircraft as set forth in claim 7, wherein said aircraft comprises one or more S-ducts, said S-ducts having an inlet and an outlet associated with an engine, and wherein said S-ducts comprise a plurality of said vortex generators therein.

9. An aircraft as set forth in claim 7, wherein said aircraft comprises a wing surface, and wherein said wing surface comprises a plurality of said vortex generators thereon.

10. An aircraft as set forth in claim 7, wherein said aircraft comprises a vertical stabilizer surface, and wherein said vertical stabilizer surface comprises a plurality of said vortex generators thereon.

11. An aircraft as set forth in claim 7, wherein said aircraft comprises control surfaces, wherein said control surfaces comprise a plurality of said vortex generators thereon.

12. An aircraft as set forth in claim 7, wherein said aircraft comprises a horizontal stabilizer surface, and wherein said horizontal stabilizer surface comprises a plurality of said vortex generators thereon.

13. An apparatus for travel on or through liquids, said apparatus having a surface in contact, with said liquid, comprising:
a plurality of vortex generators for attenuating flow separation during flow of fluid over said surface, said vortex generators comprising a base with a forward end and a leading edge extending outward and rearward from said forward end to an outward end, said leading edge comprising
(a) a first angular discontinuity at a height H₁ above said base, and
(b) a second angular discontinuity at a height H₂ above said base,
said vortex generator configured for generating, adjacent said surface, at least two vortices V₁ and V₂ in said fluid.

14. A land vehicle, said land vehicle having a surface in contact with air through which said land vehicle operates, comprising:
a plurality of vortex generators for attenuating flow separation during flow of air over the surface, said vortex generators comprising a base with a forward end and a leading edge extending outward and rearward from said forward end to an outward end, said leading edge comprising
(a) a first angular discontinuity at a height H₁ above said base, and
(b) a second angular discontinuity at a height H₂ above said base,
each of said vortex generators configured for generating, adjacent the surface, at least two vortices V₁ and V₂ in air.

15. A land vehicle as set forth in claim 14, wherein said land vehicle comprises a truck.

16. A land vehicle as set forth in claim 14, wherein said land vehicle comprises a car.

17. A land vehicle as set forth in claim 16, wherein said car comprises a race car.

18. A wind turbine, comprising:
a plurality of rotatable blades, said rotatable blades each comprising an aerodynamic surface;
a plurality of vortex generators for attenuating flow separation during flow of air over the aerodynamic surface, said vortex generators comprising a base with a forward end and a leading edge extending outward and rearward from said forward end to an outward end, said leading edge comprising
(a) a first angular discontinuity at a height H₁ above said base, and
(b) a second angular discontinuity at a height H₂ above said base,
said vortex generator configured for generating, adjacent said aerodynamic surface, at least two vortices V₁ and V₂ in said fluid.

19. A wind turbine as set forth in claim 18, wherein said height H₁ is about 1.6 times the result of height H₂ minus height H₁.

20. The wind turbine as set forth in claim 18, wherein vortice V₁ is first generated adjacent said base, and wherein said vortice V₂ is first generated outward from vortice V₁, and wherein momentum imparted to said fluid by said vortex generator rotates said vortice V₂ toward said base.

21. The wind turbine as set forth in claim 20, wherein said leading edge further comprises a third angular discontinuity at a height H₃ above said base, said vortex generator configured for generating a third vortice V₃.

22. The vortex generator as set forth in claim 21, wherein height H₂ is about 1.6 times the result of height H₃ minus height H₂.

23. The vortex generator as set forth in claim 21, wherein vortice V₃ is first generated adjacent said vortice V₂, and wherein momentum imparted to said fluid by said vortex generator rotates said vortice V₃ toward said base.

24. A vortex generator array for attenuating flow separation during flow of a fluid over a surface, comprising:
a first vortex generator, said first vortex generator comprising a base with a forward end and a leading edge extending outward from said forward end to an outward end, said leading edge comprising a first angular discontinuity at a height H₁ above said base, said first vortex generator sized and shaped to generate a first vortice V₁ in said fluid;
a second vortex generator, said second vortex generator comprising a second base with a second forward end and a second leading edge extending outward from said second forward end to a second outward end, said second outward end comprising a second angular discontinuity at a height H₂ above said base, said second vortex generator sized and shaped to generate a second vortice V₂ in said fluid; and
wherein said first vortex generator and said second vortex generator are sized, shaped, and spaced in an array so that vortice V₁ is first generated adjacent said base, and wherein said vortice V₂ is first generated outward from vortice V₁, and wherein momentum imparted to said fluid by said first vortex generator and by said second vortex generator rotates vortice V₂ toward said surface.

25. The vortex generator array as set forth in claim 24, wherein height H₁ is about 1.6 times the result of height H₂ minus height H.

26. The vortex generator array as set forth in claim 24, further comprising a third vortex generator, said third vortex generator comprising a third base with a third forward end and a third leading edge extending outward from said third base to a third outward end, said third outward end comprising a third angular discontinuity at a height H₃ above said third base, said third vortex generator sized and shaped to generate a third vortice V₃ in said fluid and wherein vortice V₃ is first generated adjacent said vortice V₂, and wherein momentum imparted to said fluid by said vortex generator array rotates the vortice V₃ toward said surface.
